(19) United States
(12) Patent Application Publication
(10) Pub. No.: US 2024/0393069 A1
(43) Pub. Date: Nov. 28, 2024

(54) METHOD OF OFFLINE CLEANING OF COOLING SYSTEMS

(71) Applicant: CHEMTREAT, INC., Glen Allen, VA (US)

(72) Inventors: Dale STUART, Glen Allen, VA (US); David N. KARLOVICH, St. Augustine, FL (US); Rajendra Prasad Kalakodimi, Glen Allen, VA (US); Raymond M. Post, Langhorne, PA (US); Robert Jones, Savannah, GA (US)

(73) Assignee: CHEMTREAT, INC., Glen Allen, VA (US)

(21) Appl. No.: 18/671,057

(22) Filed: May 22, 2024

Related U.S. Application Data
(60) Provisional application No. 63/468,334, filed on May 23, 2023.

(51) Int. Cl. F28G 9/00; C11D 1/75; C11D 3/20

(52) U.S. Cl. CPC F28G 9/00; C11D 1/75; C11D 3/2079; C11D 3/2082

(57) ABSTRACT

Methods for reducing an amount of calcium carbonate deposited on a surface of an offline condenser in a cooling system of a nuclear power plant, which include filling the offline condenser with a mixture comprising water and acetic acid and pumping the mixture through the offline condenser so as to contact the deposited calcium carbonate with the acetic acid. An amount of the acetic acid in the mixture is 1 to 25 wt %, and a temperature of the mixture is in a range of 10 to 50° C.

### BACKGROUND

In the United States, about 90% of electricity comes from thermal power plants (coal, nuclear, natural gas, and oil) that require cooling. Thermal power plants boil water to create steam, which then spins turbines to generate electricity. The heat used to boil water can come from burning of a fuel, from nuclear reactions, or directly from the sun or geothermal heat sources underground. Once the steam has passed through a turbine, it must be cooled back into water before it can be reused to produce more electricity.

Thermal power plants use three main methods of cooling.
(1) Once-through systems take water from nearby sources (e.g., rivers, lakes, aquifers, or the ocean), circulate it through pipes to absorb heat from the steam in systems called condensers, and discharge the now warmer water to the local source.
(2) Wet-recirculating or closed-loop systems reuse cooling water in a second cycle rather than immediately discharging it back to the original water source. Most commonly, closed-loop systems use cooling towers to expose water to ambient air. Some of the water evaporates; the rest is then sent back to the condenser in the power plant.
(3) Dry-cooling systems use air instead of water to cool the steam exiting a turbine. These systems tend to have higher operating costs and lower efficiencies.

The water from the circulating water system enters the condenser in a waterbox. The level in the waterbox must be maintained above the level of the uppermost tubes, otherwise the condenser will not be efficient. Generally the colder the circulating water, the more efficient the plant is. Power plants become less efficient when the condenser tubes are fouled.

Almost every cooling system condenser experiences some fouling (here, caused by the buildup of mineral scale). The circulating water source typically contains dissolved solids, which can precipitate and become strongly deposited as scale on the inner surface of the condenser tubes. Condenser tube fouling is detrimental to the heat transfer process; it reduces the efficiency of steam condensing, resulting in a lower vacuum pressure and less efficient steam turbine operation. In severe cases, poor pressure conditions in the condenser can reduce electric generating capacity by more than 50%. Thus, fouling can lead to increased fuel consumption, increasing costs and even increasing plant downtime. It is therefore important to keep the condenser clean in order to ensure reliable and efficient power generation.

Condenser cleaning is typically achieved by chemical cleaning. The most common method involves acid rinsing using a chemical solvent such as hydrochloric acid or hydrofluoric acid. However, rinsing with hydrochloric and hydrofluoric acids causes pitting and corrosion of multimetal components such as stainless steel or brass, and this cleaning method has a relatively high cost.

Other descaling agents have been investigated, but are generally less effective at removing scale. Additionally, these descaling agents are less suitable for use in condensers in nuclear power plants, which have unique requirements. For example, in nuclear power plants with a boiling water reactor (BWR), the reactor vessel serves as the boiler for the nuclear steam supply system. The steam is generated in the reactor vessel by the controlled fissioning of enriched uranium fuel which passes directly to the turbogenerator to generate electricity. In these reactors, radiation is put live into the condenser during operation. Any descaling agent must be compatible with this process. The descaling agent should also be environmentally inert because any removed materials will ultimately be introduced into a nearby water source (e.g., a lake).

Accordingly, there is a need for effective offline cleaning of cooling systems, and in particular a need for cleaning a condenser system in a thermal power plant such as a nuclear power plant.

### SUMMARY

The disclosed embodiments relate to methods for reducing an amount of calcium carbonate deposited on a surface of an offline condenser in a cooling system of a nuclear power plant. The methods immensely improve the efficiency of offline descaling operations and are compatible with the unique requirements of nuclear power plants.

In one aspect of the disclosed embodiments, the method includes filling the offline condenser with a mixture comprising water and acetic acid and pumping the mixture through the offline condenser so as to contact the deposited calcium carbonate with the acetic acid. An amount of the acetic acid in the mixture is 1 to 25 wt %, and a temperature of the mixture is in a range of 10 to 50° C.

In another aspect of the disclosed embodiments, the method includes filling the offline condenser with a mixture consisting of water, acetic acid, and an optional additive, and pumping the mixture through the offline condenser so as to contact the deposited calcium carbonate with the acetic acid. In the method, (i) an amount of the acetic acid in the mixture is 7 to 10 wt %, (ii) an amount of the optional additive in the mixture is 0 to 1 wt %, and the optional additive is oxalic acid and/or an ethoxylated amine, and (iii) a temperature of the mixture is in a range of 20 to 30° C.

### BRIEF DESCRIPTION OF THE DRAWINGS

FIG. 1 is a diagram of a condenser.

FIG. 2 is a chart showing the kinetic dependence of calcite dissolution on pH.

FIG. 3 is a chart comparing the efficacy of hydrochloric acid, dibasic acid, and acetic acid in dissolving marble.

FIG. 4 is a chart showing the change in silica concentration over time as marble is dissolved using different acids.

FIG. 5 is a chart showing the effects of hydrochloric acid, dibasic acid, and acetic acid in dissolving different marble crystallite species.

FIG. 6 is a chart showing the effectiveness of acetic acid in dissolving marble as reflected by increasing calcium and magnesium hardness over time.

FIG. 7 is a chart showing the efficacy of acetic acid in dissolving marble over time.

FIG. 8 is a chart showing the changes in pH and calcium hardness over time as measured in a first offline waterbox cooling loop in a nuclear power plant.

FIG. 9 is a chart showing the changes in pH and calcium hardness over time as measured in a second offline waterbox cooling loop in a nuclear power plant.

### DETAILED DESCRIPTION OF EMBODIMENTS

Described herein is a method for offline cleaning of cooling systems.

A typical power plant cooling system includes a condenser. Exhaust steam from the turbine is directed to the condenser where the steam is cooled and converted to water (condensate) by flowing over the tubes of the condenser. Steam ejectors (or rotary motor-driven exhausts) continuously remove air and gases from the steam and while doing so maintain vacuum.

Typically the cooling water causes the steam to condense at a temperature of about 25° C. (77° F.) and that creates an absolute pressure in the condenser of about 2-7 kPa, i.e. around 95 kPa below atmospheric pressure. The vacuum that is created through the large decrease in volume when water vapor condenses helps pull steam through the turbine for optimal efficiency.

Condenser tubes are made of brass or stainless steel for optimal heat transfer and corrosion resistance. Bacteria, algae, mud or dust and scaling from the cooling water cause internal fouling and hinder heat transfer which leads to lower vacuum and therefore lower thermodynamic efficiency.

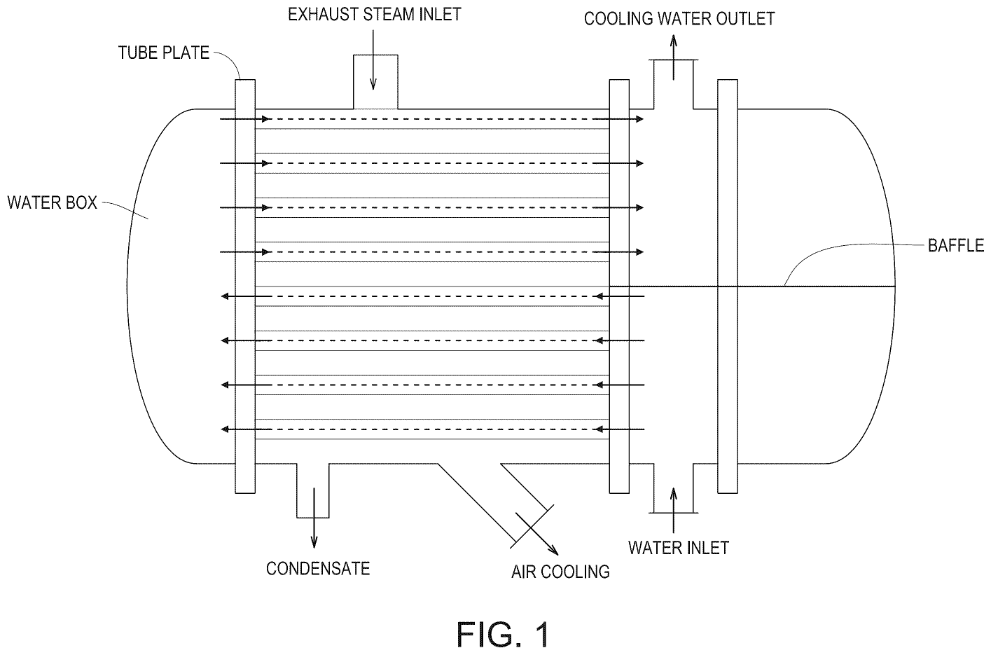

FIG. 1 is a diagram showing a typical condenser arrangement.

Condenser tubes are susceptible to scale formation. In the disclosed embodiments, a descaling agent is introduced to the condenser water loop in order to clean the condenser and reduce or eliminate scale deposits.

The descaling agent comprises a descaling compound, which can be an organic acid. In the disclosed embodiments, at least a fraction of the descaling compound is acetic acid (CH₃COOH). For example, acetic acid comprises at least 60 wt %, 70 wt %, 80 wt %, 90 wt %, 95 wt %, or 99 wt % of the descaling compound present in the descaling agent.

As used herein, weight percentages of acetic acid are based on glacial acetic acid. For example, a mixture comprising 60 wt % acetic acid is a mixture comprising 60 wt % glacial acetic acid.

The descaling agent can include 100% organic acids or can be mixed with water, e.g., so that water comprises 10 to 90 wt %, 25 to 80 wt %, or 45 to 70 wt % of the descaling agent.

Applicant found that a descaling agent comprising acetic acid is surprisingly efficient at descaling calcium carbonate scale when used for cleaning offline cooling systems. The descaling agent was effective even without requiring any other organic acid compounds (such as dibasic acid and its constituent acids), and even in the absence of hydrochloric acid or other strong acids or chlorides.

As used herein, “strong acid” means an acid that completely dissociates into its ions (H⁺ and an anion) when mixed with water. For example, hydrochloric acid (HCl), nitric acid (NO₃), sulfuric acid (H₂SO₄), hydrobromic acid (HBr), hydroiodic acid (HI), perchloric acid (HClO₄) and chloric acid (HClO₃) are examples of strong acids.

“Dibasic acid” (DBA) herein means a mixture of succinic acid, adipic acid, and glutaric acid. For example, DBA may include 25.3 wt % succinic acid, 13.2 wt % adipic acid, and 61.5 wt % glutaric acid.

“Offline” herein encompasses situations in which the entire condenser system is offline (cooling water is not circulating), or the condenser system is only partially offline. For example, the disclosed embodiments include the static soaking of half of a condenser while the unit is online but being cooled by the other half of the condenser. In one scenario, a split condenser can be cooled on one side by cooling water supplied by a first main circulating water pump, and on the other by a second main circulating water pump. The first pump can be shut down in order to isolate one side of the condenser (for example, by closing its butterfly valves). It is then possible to fill and statically soak the isolated side. Meanwhile, the other side is still circulating water and cooling the condenser. This process can be performed in the winter so that the water is cold enough to have the unit still operating at full or near full load.

Without being bound by theory, it is believed that acetic acid is remarkably more efficient at descaling as a result of two different mechanisms of action.

(1) Acetic acid has a pKa of 4.74, and although it contains only a single acid group, its concentration of acid groups per molecular weight (1 group/60.05 g/mol) is higher than most other organic acids. Accordingly, acetic acid effectively lowers the pH, which breaks the calcium carbonate crystal matrix and allows the water to form a shell of hydration. The lower pH also sets up a CO₂-bicarbonate equilibrium, meaning that the more soluble calcium bicarbonate species is more likely to form than the less soluble calcium carbonate.

(2) Acetic acid sequesters calcium when present a system operating in the pH range of 4.5 to 6.0.

Acetic acid is therefore a stronger acid with increased sequestration capacity relative to other organic acids (e.g., adipic acid, formic acid, lactic acid). Acetic acid also has a relatively low molecular weight, meaning that it can diffuse more quickly.

Additionally, acetic acid was found to dissolve calcium carbonate in a controlled fashion, which is important for very large condensers since calcium carbonate scale releases large volumes of CO₂ gas which must be safely vented outside the turbine building without developing excessive pressure in the condenser.

In some embodiments, the descaling agent includes other additives in addition to the acetic acid. The amount of the other additives in the descaling agent can total 0.01 to 10 wt %, 0.1 to 5 wt %, or 0.5 to 1 wt %, for example.

For example, the descaling agent can include a corrosion inhibitor effective for preventing corrosion of any carbon steel components present in the system. The corrosion inhibitor may be, for example, oxalic acid.

The descaling agent can also include a surfactant in order to solubilize and transport low charge species like clay and other silicates that could potentially reduce the effectiveness of the acetic acid. Suitable surfactants include propylene ethoxylate block polymers, ethoxylated amines (e.g., ethoxylated tallow amine, JEFFAMINE (C₁₂H₂₈N₂O₃)), and sulfonated ethoxylates. Amines are particularly suitable because they become more soluble at low pH and therefore can disperse in the acetic acid.

The descaling agent is typically diluted in water before or while adding the descaling agent to a cooling system. The descaling agent can be diluted in water so that the final concentration of acetic acid in the water circulating through the offline cooling system is about 1 to 25 wt %, 3 to 20 wt %, 5 to 15 wt %, or 7 to 10 wt %, for example.

The descaling agent can include other acids or chlorides in in a total amount that is less than the amount of acetic acid in the descaling agent. The other acids could include, for example, hydrochloric acid or DBA. The final concentration of DBA, chlorides, and/or strong acids in the water circulating through the offline cooling system is less than 1 wt %, less than 0.5 wt %, less than 0.3 wt %, or less than 0.1 wt %, for example.

The other acids in the descaling agent could include alpha hydroxy acids (for example, glycolic acid or lactic acid) or sulfamic acid. These acids help accelerate cleaning by counteracting the poor diffusion of calcium acetate, which causes concentrations to approach and exceed solubility limits in the micro environments close to the scale. Alpha hydroxy acids and sulfamic acid form more polar complexes with acetic acid and calcium, leading to stronger diffusion, and also increase the solubility limit by creating different complexes.

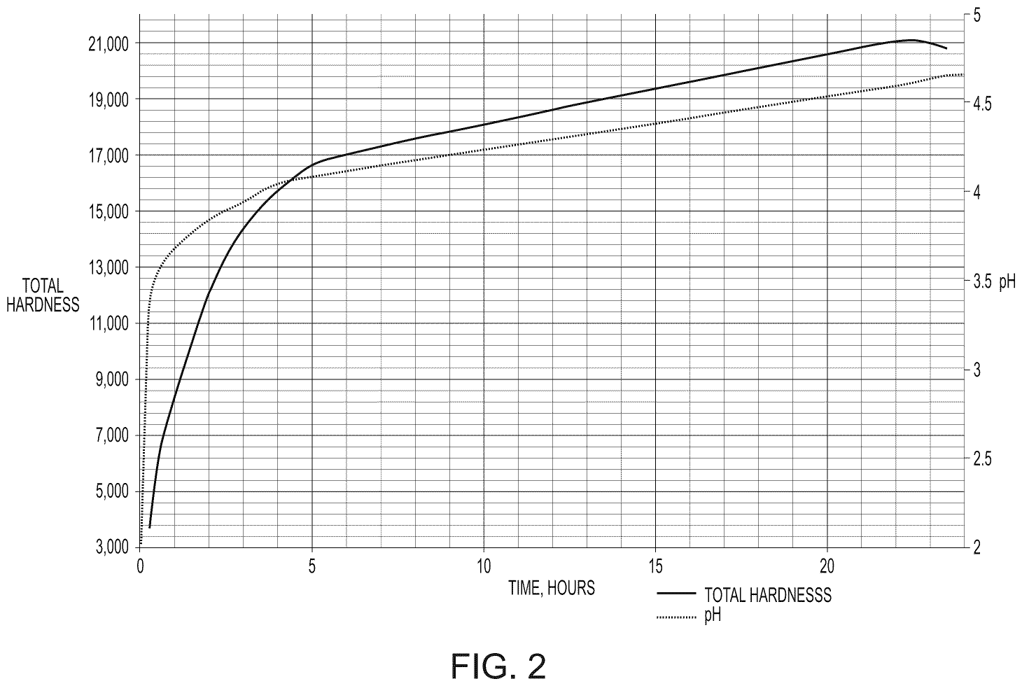

The descaling agent can be circulated through the system at a predetermined pH. For example, the mixture of water and descaling agent pumped through the system is preferably maintained at a pH of less than 4. When the pH is less than 4, the dissolution kinetics of the cleaning process are at an accelerated pace. FIG. 2 shows the dissolution rate of calcite when excess marble (calcite, dolomite, calcium alumiosilicates) was treated 10% glacial acetic acid, illustrating the kinetic dependence on pH. Thus, the pH of the mixture of water and descaling agent is preferably 3.7 or less, 3.5 or less, 3.2 or less, or even 3.0 or less.

The increased concentration of acetic acid at a pH of 3.2, for example, provides a significant buffering capacity that will resist elevation of the pH. This helps maintain the pH of the cleaning solution (water and descaling agent) at less than 4 as it passes through the heat exchanger tube and becomes neutralized by the scale, thus increasing the cleaning rate.

To maintain the desired pH of the cleaning solution, it may be helpful to monitor the concentration of acetic acid in the cleaning solution. This can be done using dye tracing, for example.

The descaling agent does not require any heated tanks, and can effectively remove scale at a range of temperatures including temperatures below 50, 40, 30, 20, or even 10° C. For example, the descaling agent can be used to clean a cooling system at room temperature (˜ 20-22° C.).

The descaling agent can be pumped through the condenser for at least 1 hour, 5 hours, 10 hours, 24 hours, or 48 hours. After circulating the descaling agent through the condenser for this period of time, more descaling agent can be injected and circulated through the system. This process can be repeated as many times as needed to effectively remove the scale, depending on the expected amount of scale formation.

The descaling agent (in its diluted form) can be pumped through the condenser at a flow rate of 100 to 600 gpm, 250 to 500 gpm, or 300 to 400 gpm, for example.

The descaling agent can be circulated through the system for a preset period of time, or it can be circulated until system measurements suggest that descaling is sufficiently complete. For example, the descaling agent can be circulated through the system until the pH of the diluted descaling agent circulating through the system changes by less than 0.5, less than 0.2, or less than 0.1 over the course of 5 hours. Or the descaling agent can be circulated through the system until the calcium hardness (measured as CaCO₃) of the diluted descaling agent circulating through the system changes by less than 5,000, less than 2,000, or less than 1,000 ppm over the course of 5 hours.

### EXAMPLES

To study the effectiveness of acetic acid on descaling calcium carbonate, Applicant conducted various studies, as described below.

### Example 1

In order to study the effectiveness of acetic acid in dissolving marble as compared to other acids, the following study was performed.

Marble rock was soaked over 28.5 hours in one of the following samples:
5 wt % HCl in water
9 wt % dibasic acid (DBA) in water
10 wt % acetic acid in water

As used throughout these examples, the dibasic acid included 25.3 wt % succinic acid, 13.2 wt % adipic acid, and 61.5 wt % glutaric acid.

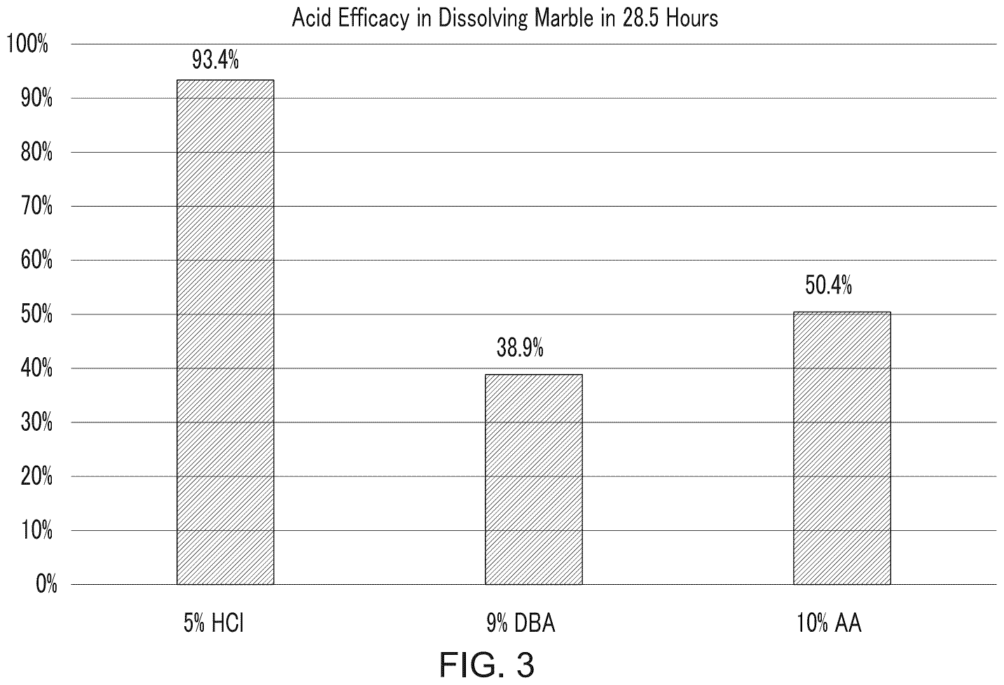

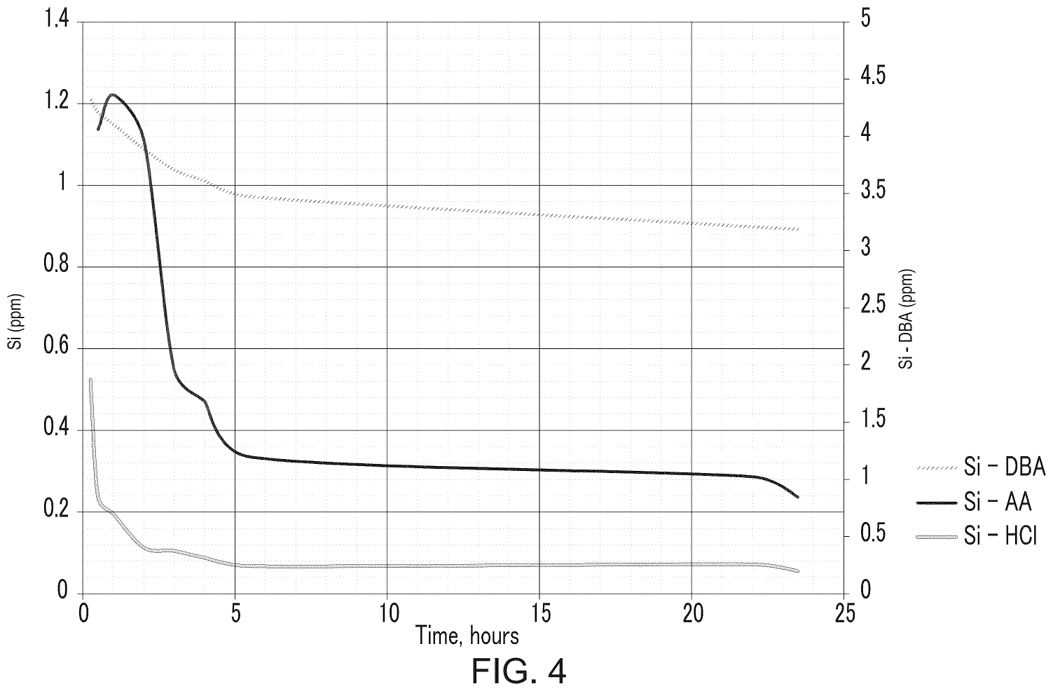

The pH, total hardness, dissolution efficacy, and silica concentration were monitored over time and compared for the different sample solutions. The test results are summarized in Tables 1-3 below, as well as in FIGS. 3 and 4.

TABLE 1
5% HCl

| Time, | | | Ca, as | Mg, as | total | |
|---|---|---|---|---|---|---|
| hours | pH | Acidity | CaCO₃ | CaCO₃ | hardness | Temp |
| 0.00 | 1.06 | 53,596 | | | | 21.8 |
| 0.25 | 0.7 | | 19410 | 2029 | 21439 | 22.6 |
| 0.50 | 0.6 | | 21950 | 3206 | 25156 | 22.3 |
| 1.00 | 0.56 | | 22900 | 3998 | 26898 | 22 |
| 2.00 | 1 | | 23330 | 4563 | 27893 | 21 |
| 3.00 | 0.91 | 1,434 | 23620 | 4698 | 28318 | 20.1 |
| 4.00 | 0.98 | 1,255 | 23570 | 4730 | 28300 | 19.7 |
| 5.50 | 1.38 | 1,076 | 23550 | 4776 | 28326 | 19.5 |
| 22.00 | 1.6 | 538 | 24730 | 5212 | 29942 | 19.3 |
| 23.50 | 2.01 | 538 | 25060 | 5154 | 30214 | 19.6 |
| 28.50 | 2.05 | 140 | | | | 19.7 |

TABLE 2
9% DBA

| Time, | | | Ca, as | Mg, as | total | |
|---|---|---|---|---|---|---|
| hours | pH | Acidity | CaCO₃ | CaCO₃ | hardness | Temp |
| 0.00 | 1.92 | 18,821 | | | | 26.8 |
| 0.25 | 3.36 | | 2579 | 133 | 2712 | 24.8 |
| 0.50 | 3.61 | | 4284 | 193 | 4477 | 23.8 |
| 1.00 | 3.73 | | 6019 | 257 | 6276 | 22.7 |
| 2.00 | 3.9 | | 8508 | 363 | 8871 | 21.3 |
| 3.00 | 3.98 | 5,557 | 10190 | 435 | 10625 | 20.2 |
| 4.00 | 4.1 | 5,557 | 11210 | 487 | 11697 | 19.7 |
| 5.50 | 4.16 | 3,944 | 12530 | 539 | 13069 | 19.5 |
| 22.00 | 4.7 | 359 | 15900 | 714 | 16614 | 19.2 |
| 23.50 | 4.68 | 359 | 15830 | 714 | 16544 | 19.5 |
| 28.50 | 4.63 | 100 | | | | 19.5 |

TABLE 3
10% acetic acid

| Time, | | | Ca, as | Mg, as | total | |
|---|---|---|---|---|---|---|
| hours | pH | Acidity | CaCO₃ | CaCO₃ | hardness | Temp |
| 0.00 | 2.02 | 17,925 | | | | 21.4 |
| 0.25 | 3.36 | | 3460 | 189 | 3649 | 21.2 |
| 0.50 | 3.55 | | 5917 | 266 | 6183 | 21 |
| 1.00 | 3.68 | | 8114 | 356 | 8470 | 20.8 |
| 2.00 | 3.84 | | 11600 | 521 | 12121 | 20.3 |
| 3.00 | 3.94 | 6,509 | 13730 | 636 | 14366 | 19.8 |
| 4.00 | 4.04 | 4,840 | 14980 | 707 | 15687 | 19.5 |
| 5.50 | 4.1 | 1,255 | 16050 | 790 | 16840 | 19.3 |
| 22.00 | 4.59 | 359 | 19920 | 1086 | 21006 | 19.1 |
| 23.50 | 4.65 | 179 | 19680 | 1072 | 20752 | 19.4 |
| 28.50 | 4.67 | 40 | | | | 19.5 |

The findings can be summarized as follows:
pH changes
   5% HCl changed from 1.1 to 2.1
   9% DBA and 10% acetic acid changed from 2.0 to 4.6/4.7
Total hardness
   Reached 30,000, 16,500, and 21,000 ppm for HCl, DBA, and acetic acid, respectively.
93.4, 38.9, and 50.4% dissolution efficacy (where 100% efficacy is when 2 moles acid remove 1 mole Ca) for HCl, DBA, and acetic acid, respectively, as estimated by measuring marble weight loss.
Silica concentration in solution reached an early maximum in both the HCl and acetic acid solutions. The concentration in the acetic acid solution decreased by more than 67% from 1.2 ppm SiO₂ in the first hour of the experiment down to <0.4 ppm 5 hours into the experiment, which may indicate precipitation. The DBA solution had a more modest decrease of only 27% from 4.4 ppm SiO₂ (3.7 times higher than in the acetic acid solution) down to 3.2 ppm, indicating that the DBA was potentially able to remove more silica and maintain more silica in solution throughout the experiment compared to the acetic acid solution.

The results demonstrate that acetic acid is superior to DBA in dissolving calcium carbonate, and can achieve good dissolution results without lowering the pH.

### Example 2

In order to study the effectiveness of acetic acid in reducing different marble deposit species, the following study was performed.

A marble sample was soaked for 30 hours in 10 wt % acetic acid in water. Solids analysis of the marble was performed by x-ray diffraction to determine the effect of the acetic acid on the constitution of the marble. Additionally, the acetic acid solution was periodically sampled to analyze dissolved chemical species present in the water.

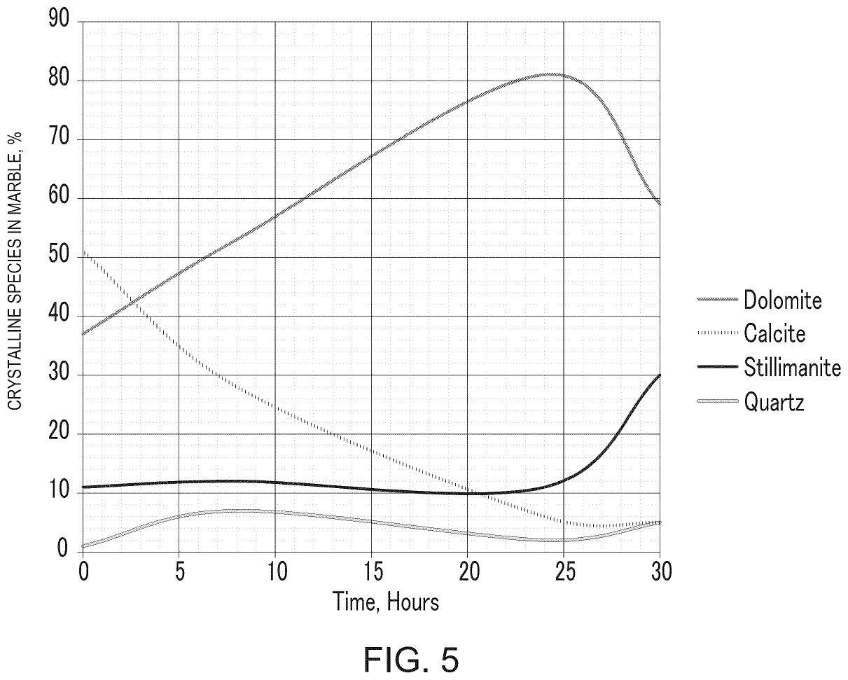

As shown in FIG. 5, there was a consistent decrease of calcite (Ca₆C₆O₁₈); an increase in dolomite (Ca_{3.21}Mg_{2.79}C₆O₁₈) until 24 hours before sharply decreasing; a steady concentration of stillimanite (Al₈Si₄O₂₀ and Al_{7.92}Fe_{0.08}Si₄O₂₀) until 24 hours and then a sharp increase; and a low consistent concentration of quartz (Si₃O₆). Together this indicates that acetic acid preferentially acts on calcite, dolomite will solubilize when calcite is mostly eliminated, quartz is consistently removed, and stillimanite (aluminum silicate) does not dissolve very well.

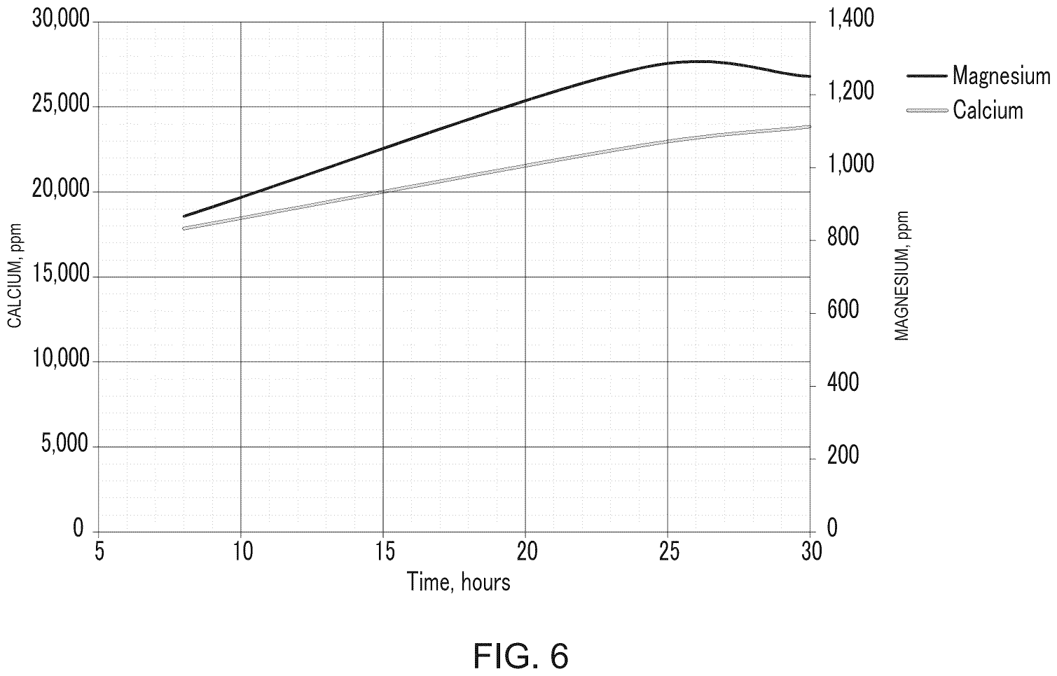

As shown in FIG. 6, there was a consistent increase in the total hardness over time based on calcium hardness (as ppm CaCO₃) and magnesium hardness (as ppm CaCO₃).

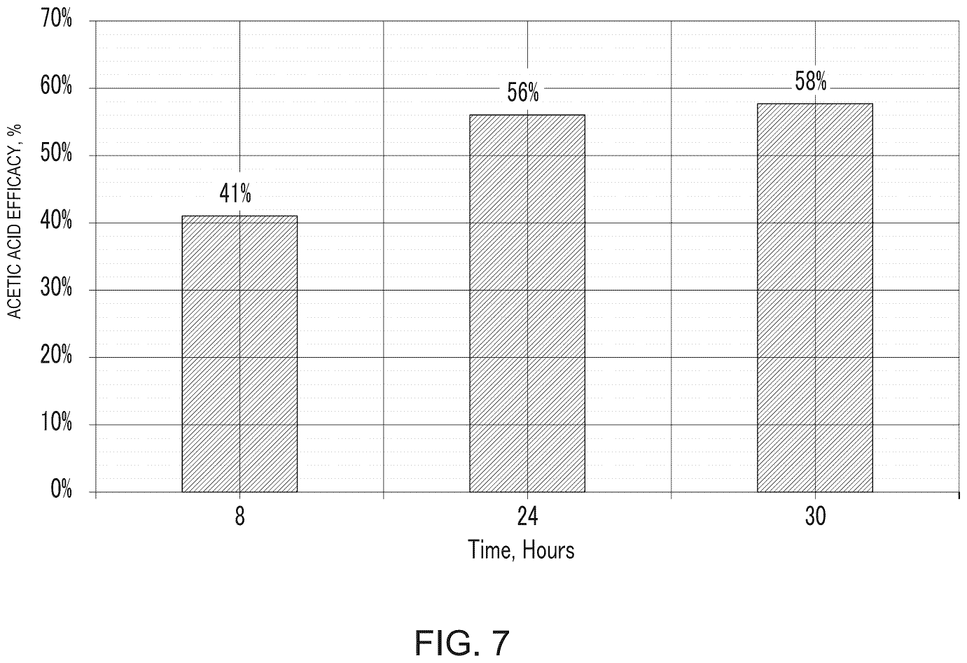

The overall efficacy of the acetic acid in dissolving the marble was calculated and is shown in FIG. 7. It was determined that acetic acid was very effective in dissolving marble.

### Example 3

In order to monitor the effectiveness of acetic acid on dissolving calcite powder, the following study was performed.

A solution consisting of either 10 wt % acetic acid in water, or 9 wt % DBA in water, was added to calcite powder. The pH and calcium hardness (as CaCO₃) were measured, as well as the dissolution efficacy (as estimated by measuring powder weight loss).

When the solution having acetic acid was used, the pH changed from 2.0 to 5.2, and the calcium hardness increased to 108,400 ppm. The solution with acetic acid exhibited an efficacy of 85.3%, as compared to only 80.0% efficacy when using DBA.

These results confirmed that acetic acid is superior to DBA for descaling calcite, which is the most stable polymorph of calcium carbonate.

### Example 4

In order to monitor the effectiveness of the descaling agent in a cooling system, Applicant conducted condenser descaling using a descaling agent comprising acetic acid. The cooling system was part of a nuclear power plant.

A descaling agent comprising ˜56 wt % acetic acid in water was used to clean a 0.020-inch coating of calcium carbonate scale from a condenser, amounting to approximately 150,000 lbs. of scale. The descaling agent did not include any chloride or other acids.

49,500 gallons (430,856 pounds) of the descaling agent was injected to two condenser waterboxes together with service water (to reach a final acetic acid concentration of 10 wt %) and recirculated for 34 hours until chemistry measurements indicated that all calcium carbonate scale had been dissolved. Following the cleaning, the waterboxes were dewatered and refilled with service water twice to prepare them for inspection and dimple plug leak testing. Approximately two tons (4,077 pounds) of calcium carbonate scale were removed by the process based on chemical analysis of the cleaning solution. More details are provided below.

Two centrifugal pumps with check valves were used to inject the descaling agent into the condenser waterboxes through 4″ SS braided hoses and Seametrics flow/totalizer meters at the condenser tube pull area. After passing through the totalizers, 6″ hoses were tee'd in at the condenser tube pull pit to bring service water from globe valves. Gate valves for the service water were located in the tube pull area, providing redundant means to control service water flow. Service water also flowed through Seametrics flow/totalizer meters. The service water and descaling agent were connected to the inlet of VFD-controlled centrifugal pumps with a nominal maximum flow capability of 2,000 gpm. Two pumps, primary and secondary, on each of two sides (4 pumps total) were used to inject and circulate the cleaning solution into the waterboxes independently through 6″ hoses.

Water was drained down to the 65% full level on both waterboxes. Valves were aligned to recirculate into the upper inlet manways, through the condenser tubes and out through the lower outlet manways. Baseline chemistry tests for pH, calcium hardness, and conductivity were made on both waterbox recirculating loops.

Recirculating flow was initiated through the first (East) waterbox, entering at the top manway on the north side and returning from the lower manway on the south side of the waterbox. Approximately 1 gallon of antifoam was added to the first waterbox loop as a precautionary measure against foaming. Descaling agent was injected into the recirculating loop at an injection rate of 380 gpm until 15,360 gal of the descaling agent was added.

Recirculating flow was then started for the second (West) waterbox. Approximately 1 gallon of antifoam was added to the second waterbox loop and descaling agent was added into the recirculation loop at a rate of 380 gpm.

Both waterbox recirculating loops were continuously operating to move descaling agent through the condenser system.

Approximately four hours after initiated the descaling agent inject to the first waterbox recirculating loop, a second descaling agent addition was initiated to the first waterbox recirculating loop. A total of 22,774 gal of the descaling agent was added to the loop. After this second injection, the first recirculation pumps were turned off and the valves were aligned to inject service water. The VFD-controlled recirculation pump speed was ramped up slowly in order to avoid a flow surge that might reach the waterbox vent level.

The process was repeated on the second loop. A total of 27,330 gallons of the descaling agent were injected into the second loop. Recirculation of service water was resumed on the second loop with the pump speed being ramped up slowly to avoid a surge.

Recirculation was continued on both waterbox loops and pH, calcium, and conductivity measurements were made on an approximately hourly basis. Service water was added periodically to maintain descaling agent levels in both loops. The descaling agent was recirculated for over 24 hours until chemistry values (steady calcium levels and no pH rise) indicated that all calcium carbonate scale had been dissolved.

Following recirculation, both loops were drained, refilled with service water, and recirculated.

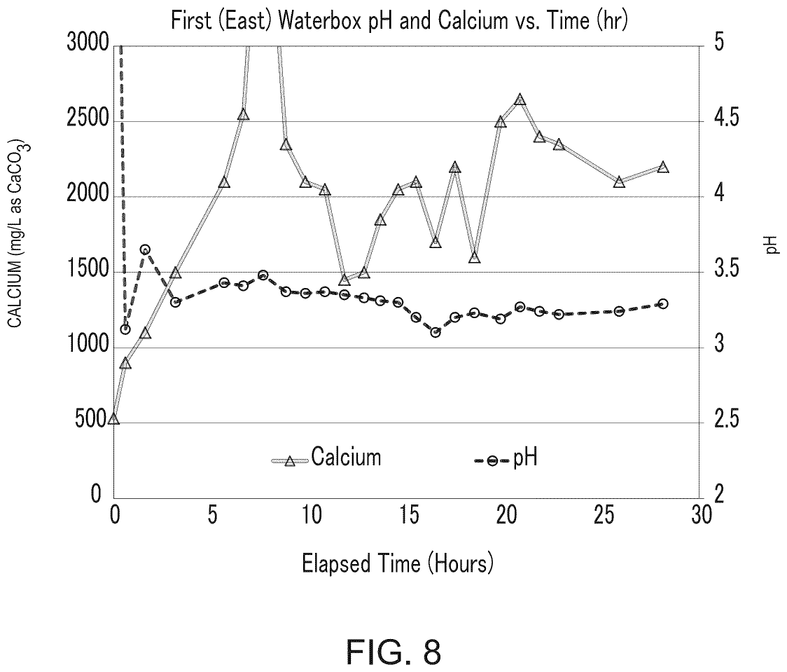

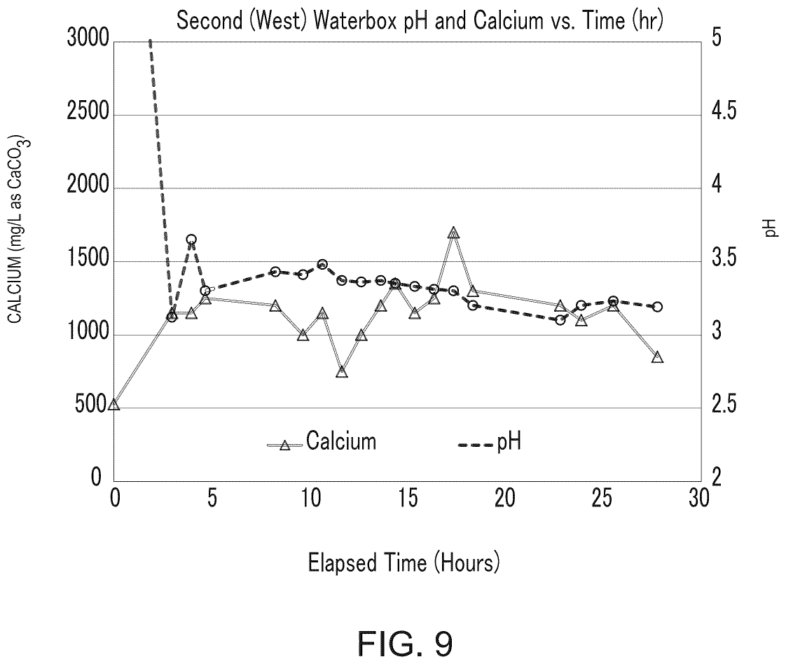

The results are summarized in FIGS. 8 and 9, reporting the calcium and pH levels as a function of time for each of the first and second waterboxes, respectively. The descaling process was continued until chemistry results indicated that the calcium and pH of the cleaning solution were no longer increasing, indicating that the calcium carbonate scale had been effectively removed. The estimated total quantity of calcium carbonate scale removed was 4,077 pounds.

In this study, the pH was ≤3.5, and the calcium hardness (as CaCO₃) was ≤1,500 ppm. This suggests that efficient descaling could have been achieved with even lower concentrations of acetic acid.

The study demonstrated that the descaling agent does not require heated tanks, has a very high calcium solubility, has a favorable environmental profile, and can be made available in bulk quantities. The descaling agent dissolves calcium carbonate in a controlled fashion, which is important for very large condensers since calcium carbonate scale releases large volumes of CO₂ gas which must be safely vented outside the turbine building without developing excessive pressure in the condenser.

### Example 5

In order to monitor the relationship between the concentration of acetic acid and the pH of the cleaning solution, Applicant titrated samples of cleaning solution being circulated through a series of condensers (Unit #1 and Unit #2). Dye tracing was used to monitor the concentration of acetic acid in the circulating solution (in terms of wt % glacial acetic acid), and the pH was measured. The results are summarized in Table 4 below.

TABLE 4

| pH | Unit #1 | Unit #2 |
|---|---|---|
| 3.7 | 0.46% | 0.50% |
| 3.5 | 0.71% | 0.75% |
| 3.2 | 1.47% | 1.51% |
| 3 | 2.47% | 2.45% |
| 2.75 | 4.44% | 4.74% |
| 2.5 | 8.76% | 9.56% |
| 2.25 | 17.29% | 20.50% |

It was found that the concentration of acetic acid in the descaling agent that is needed to achieve a particular pH varies by pH level. For example, the concentration of acetic acid needed to reach a pH of 3.5 was only 0.75 wt %, but twice as much acetic acid was needed to reach a pH of 3.2. This is both because the lake water is alkaline and the acetic acid is a weak acid.

While the invention has been described in conjunction with the specific exemplary embodiments thereof, it is evident that many alternatives, modifications, and variations will be apparent to those skilled in the art. Accordingly, exemplary embodiments of the invention as set forth herein are intended to be illustrative, not limiting. There are changes that may be made without departing from the spirit and scope of the invention.

What is claimed is:

1. A method for reducing an amount of calcium carbonate deposited on a surface of an offline condenser in a cooling system of a nuclear power plant, the method comprising:
filling the offline condenser with a mixture comprising water and acetic acid and pumping the mixture through the offline condenser so as to contact the deposited calcium carbonate with the acetic acid,
wherein:
an amount of the acetic acid in the mixture is 1 to 25 wt %, and
a temperature of the mixture is in a range of 10 to 50° C.

2. The method of claim 1, wherein the amount of the acetic acid in the mixture is 3 to 20 wt %.

3. The method of claim 1, wherein the amount of the acetic acid in the mixture is 5 to 15 wt %.

4. The method of claim 1, wherein the amount of the acetic acid in the mixture is 7 to 10 wt %.

5. The method of claim 1, wherein the mixture does not include a strong acid.

6. The method of claim 1, wherein the mixture does not include a chloride.

7. The method of claim 1, wherein the mixture does not include dibasic acid.

8. The method of claim 1, wherein the mixture further comprises additives selected from the group consisting of corrosion inhibitors and surfactants.

9. The method of claim 8, wherein an amount of the additives in the mixture is 0.01 to 10 wt %.

10. The method of claim 1, wherein the mixture further comprises oxalic acid.

11. The method of claim 1, wherein the mixture further comprises an ethoxylated amine.

12. The method of claim 1, wherein the temperature of the mixture is in a range of 20 to 30° C.

13. The method of claim 1, wherein the temperature of the mixture is in a range of 30 to 50° C.

14. The method of claim 1, wherein the mixture is pumped through the offline condenser for at least 24 hours.

15. The method of claim 1, further comprising:
measuring a property of the mixture as it is pumped through the offline condenser; and
removing the mixture from the offline condenser when the measured property satisfies a predetermined threshold change in value.

16. The method of claim 15, wherein:
the property is the pH of the mixture, and
the mixture is removed from the offline condenser when the pH of the mixture pumped through the offline condenser changes by less than 0.5 over the course of 5 hours.

17. The method of claim 15, wherein:
the property is the pH of the mixture, and
the mixture is removed from the offline condenser when the pH of the mixture pumped through the offline condenser changes by less than 0.2 over the course of 5 hours.

18. The method of claim 15, wherein:
the property is the calcium hardness of the mixture, as measured by ppm CaCO₃, and
the mixture is removed from the offline condenser when the calcium hardness of the mixture pumped through the offline condenser changes by less than 5,000 ppm over the course of 5 hours.

19. The method of claim 15, wherein:
the property is the calcium hardness of the mixture, as measured by ppm CaCO₃, and
the mixture is removed from the offline condenser when the calcium hardness of the mixture pumped through the offline condenser changes by less than 2,000 ppm over the course of 5 hours.

20. A method for reducing an amount of calcium carbonate deposited on a surface of an offline condenser in a cooling system of a nuclear power plant, the method comprising:
filling the offline condenser with a mixture consisting of water, acetic acid, and an optional additive, and pumping the mixture through the offline condenser so as to contact the deposited calcium carbonate with the acetic acid,
wherein:
an amount of the acetic acid in the mixture is 7 to 10 wt %,
an amount of the optional additive in the mixture is 0 to 1 wt %, and the optional additive is oxalic acid and/or an ethoxylated amine, and
a temperature of the mixture is in a range of 20 to 30° C.
